(19) United States
(12) Patent Application Publication
(10) Pub. No.: US 2017/0278418 A1
(43) Pub. Date: Sep. 28, 2017

(54) DEVICE AND METHOD FOR TESTING FINGER DEXTERITY

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YUNG-NIAN WANG, New Taipei (TW); XIAO-MAN NI, Shenzhen (CN); GUO-RONG HU, Shenzhen (CN)

(21) Appl. No.: 15/464,501

(22) Filed: Mar. 21, 2017

(30) Foreign Application Priority Data
Mar. 23, 2016 (CN) 201610169930.9

(51) Int. Cl. G09B 19/00; A63B 71/06; G01V 3/02

(52) U.S. Cl. CPC G09B 19/003; G01V 3/02; A63B 71/06

(57) ABSTRACT

A method for testing finger dexterity which is applied to a device for testing finger dexterity. The device comprises a testing mechanism with base part, sensor, metal conductive sheet, and processing unit. The base part defines a screw hole defining a first conductive point, the metal conductive sheet defines a second conductive point. The sensor detects a screw inserted into the screw hole, and produces an induction signal. The circuit board produces a trigger signal when the screw makes contact with the first conductive point and the second conductive point. The processing unit receives and analyzes the time lengths between signals and repetitions of signals, and generates a testing result accordingly as a measure of manual dexterity.

### CROSS-REFERENCE TO RELATED APPLICATIONS

This application claims priority to Chinese Patent Application No. 201610169930.9 filed on Mar. 23, 2016, the contents of which are incorporated by reference herein.

### FIELD

The subject matter herein generally relates to the field of finger dexterity testing, especially relates to a device and a method for testing finger dexterity.

### BACKGROUND

Finger dexterity testing devices are not yet capable of automatically analyzing testing results or displaying the testing results to their users.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view showing an exemplary embodiment of a device for testing finger dexterity.

FIG. 2 is an exploded, isometric view of a portion of the device of FIG. 1.

FIG. 3 is an another exploded, isometric view of a portion of the device of FIG. 1.

FIG. 4 is a cross sectional view along V-V line of FIG. 2.

FIG. 5 is a block diagram of one exemplary embodiment of the device for testing finger dexterity of FIG. 1.

FIG. 6 is a flowchart of one exemplary embodiment of a method for testing finger dexterity.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” indicates “including, but not necessarily limited to”; it specifically indicates open-ended inclusion or membership in a so-described combination, group, series and the like.

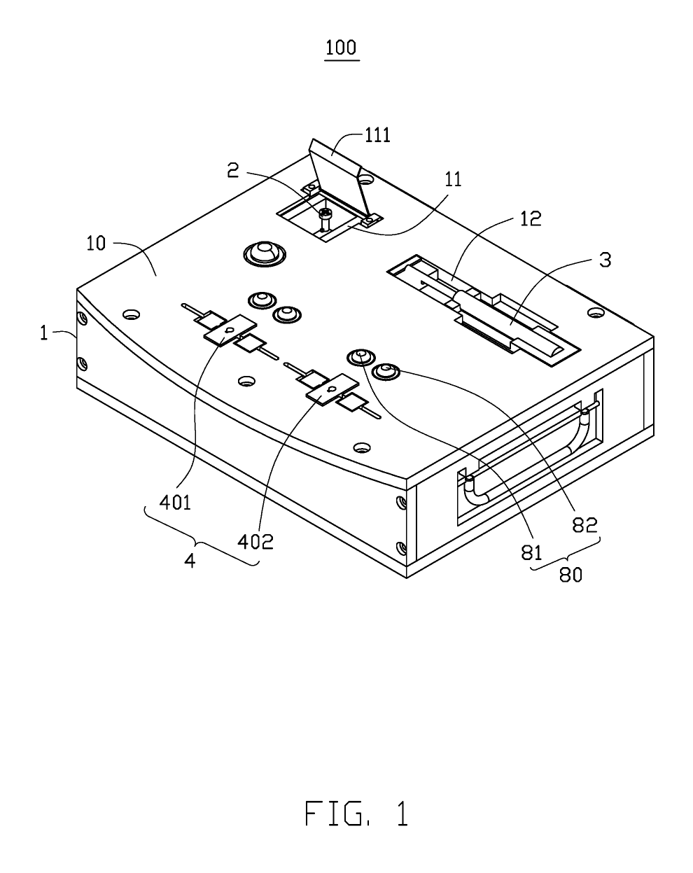

FIG. 1 illustrates an embodiment of a device 100 for testing finger dexterity. The device 100 includes a box 1 and at least one testing mechanism 4. The at least one testing mechanism 4 is mounted on a shell 10. The box 1 is able to receive a screw 2 and a screwdriver 3. In at least one embodiment, the screwdriver 3 and the screw 2 are magnetic, the screwdriver 3 and the screw 2 can attract each other through magnetism. The screw 2 is conductive.

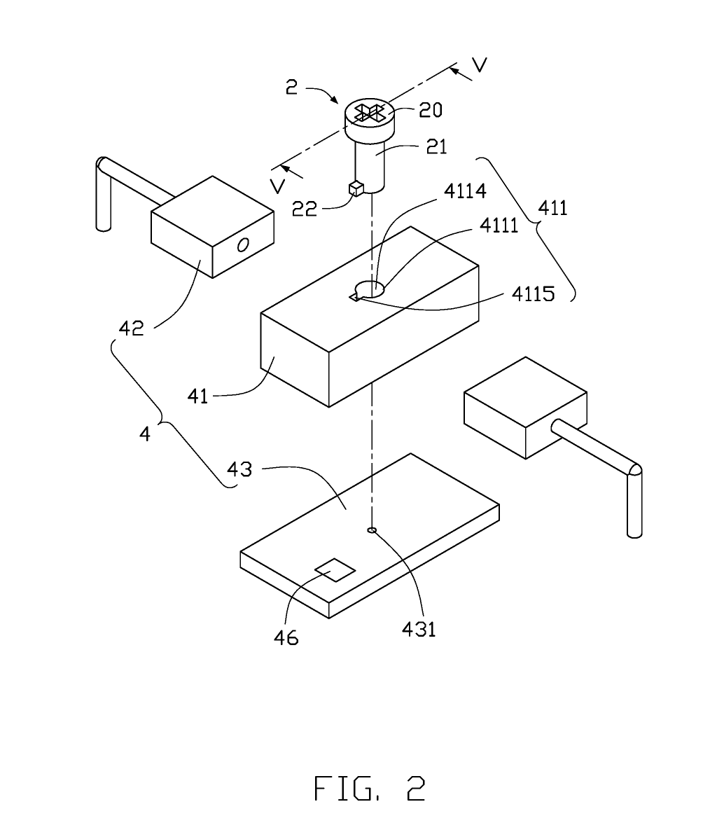

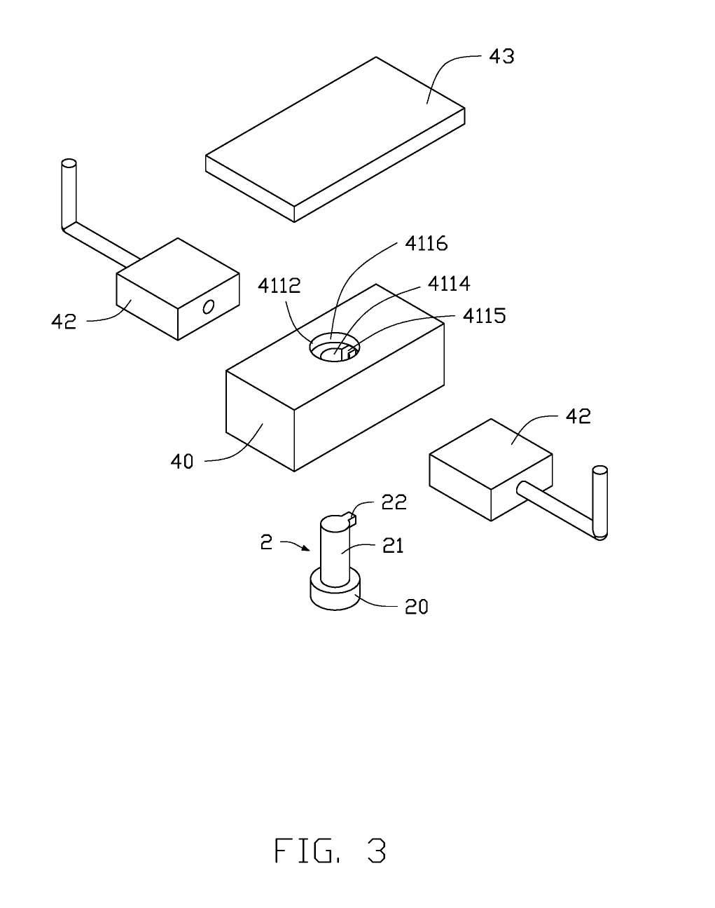

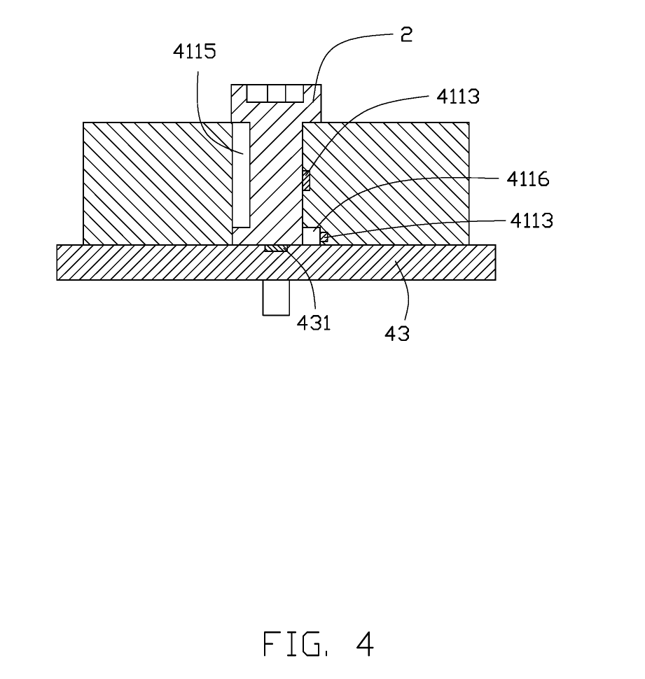

FIG. 2 illustrates an exploded view of a portion of the device 100 of FIG. 1. The testing mechanism 4 includes a base part 41, a sensor 42, and a metal conductive sheet 43. The base part 41 is mounded on the shell 10. The base part 41 defines a screw hole 411 matched with the screw 2. As FIGS. 3-4 illustrate, the screw hole 411 includes an open end 4111, a bottom end 4112, and at least one first conductive point 4113 (shown in FIG. 4). The at least one first conductive point 4113 is set in the screw hole 411 and located between the open end 4111 and the bottom end 4112. The sensor 42 is set on the base part 41 near the screw hole 411. The sensor 42 detects the screw 2 being inserted into the screw hole 411, and produces an induction signal when the screw 2 is inserted into the screw hole 411. The metal conductive sheet 43 is set on the bottom end 4112. The metal conductive sheet 43 defines a second conductive point 431. When the screw 2 is inserted into the screw hole 411, the first conductive point 4113 is able to connect with the second conductive point 431, by the conductive screw 2. In at least one embodiment, the device 100 further includes a circuit board 46. The circuit board 46 connects with the metal conductive sheet 43. When the screw 2 makes contact with the first conductive point 4113 set in the screw hole 411 and the second conductive point 431 set on the metal conductive sheet 43, the circuit board 46 produces a trigger signal. In at least one embodiment, the trigger signal can be a voltage signal or a current signal.

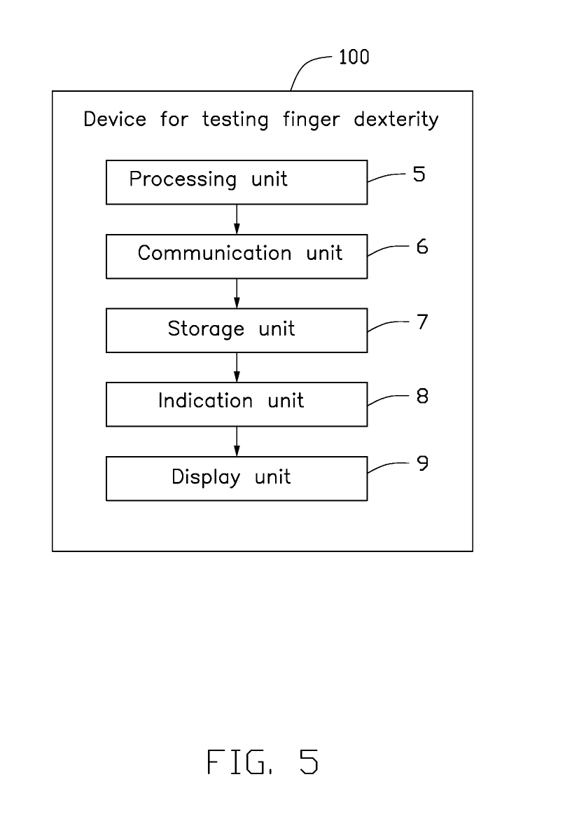

FIG. 5 illustrates one embodiment of the device 100 for testing finger dexterity of FIG. 1. The device 100 includes a processing unit 5, a communication unit 6, and a storage unit 7. The processing unit 5 both connects with the sensor 42 and the circuit board 46. The processing unit 5 receives the induction signal sent by the sensor 42 and the trigger signal sent by the circuit board 46 within a preset time, analyzes the induction signal and the trigger signal, and generates corresponding testing result. The processing unit 5 displays the generated testing data and testing result to user. For example, the preset time can be 1 minute.

The device 100 for testing finger dexterity can communicate with an electronic device (not shown) by the communication unit 6. The device 100 sends the generated testing data and testing result to the electronic device. The storage unit 7 is used to store the data of the device 100. For example, the data of the device 100 can be the testing data and/or testing result. In at least one embodiment, the storage unit 7 can include various types of non-transitory computer-readable storage mediums. For example, the storage unit 7 can be an internal storage system, such as a flash memory, a random access memory (RAM) for temporary storage of information, and/or a read-only memory (ROM) for permanent storage of information. The storage unit 7 can also be an external storage system, such as a hard disk, a storage card, or a data storage medium. The processing unit 5 can be a central processing unit (CPU), a microprocessor, or other data processor chip that performs functions for analyzing the induction signal and the conductive signal, and generating corresponding testing data and testing result in the device 100 for testing finger dexterity.

The shell 10 defines a first receiving cavity 11 for receiving the screw 2 and a second receiving cavity 12 for receiving the screwdriver 3 (referring to FIG. 1). The shell 10 also defines a cover 111. The cover 111 is able to cover the first receiving cavity 11.

The screw hole 411 further includes a first hole 4114, a second hole 4115, and a third hole 4116 (referring to FIGS. 2-3). One end of the first hole 4114 and one end of the second hole 4115 connect with the open end 4111, the other end of the first hole 4114 and the other end of the second hole 4115 connect with the third hole 4116. The third hole 4116 connects with the bottom end 4112. The screw 2 includes a top part 20, a column body 21, and a bump 22. One end of the column body 21 connects with the top part 20, and the other end of the column body 21 connects with the bump 22. The screw 2 can be inserted into the screw hole 411 by sliding the bump 22 of the screw 2 along the second hole 4115. When the screw 2 is received in the screw hole 411, the column body 21 of the screw 2 is received in the first hole 4114, the bump 22 of the screw 2 is received in the third hole 4116, and the top part 20 is exposed above the first hole 4114.

In at least one embodiment, as shown in FIG. 4, the screw hole 411 includes two first conductive points 4113. One first conductive point 4113 is set on an inner wall of the first hole 4114, the other first conductive point 4113 is set on an inner wall of the third hole 4116. When the screw 2 makes contact with the first conductive point 4113 in the first hole 4114 and the second conductive point 431 on the metal conductive sheet 43, the circuit board 46 produces a first trigger signal. When the screw 2 makes contact with the first conductive point 4113 in the third hole 4116 and the second conductive point 431 on the metal conductive sheet 43, the circuit board 46 produces a second trigger signal.

The processing unit 5 receives the induction signal sent by the sensor 42 and the first and second trigger signals sent by the circuit board 46, analyzes the induction signal and the first and second trigger signals, generates corresponding testing data and testing result, and sends the generated testing data and testing result to the electronic device (e.g., a smart phone) for the user to view.

In at least one embodiment, a user inserts the screw 2 into the screw hole 411 or extracts the screw 2 from the screw hole 411 by operating the screwdriver 3 manually. As such, the user finger's dexterity can be tested based on counting the number of operations of the screwdriver 3 to insert the screw 2 into the screw hole 411 and extract the screw 2 from the screw hole 411 within a preset time.

In detail, the box 1 includes two testing mechanisms 4. The two testing mechanisms 4 includes a first testing mechanism 401 and a second testing mechanism 402. When the user starts to repeatedly operate the screwdriver 3 to insert the screw 2 into the screw hole 411 and extract the screw 2 from the screw hole 411 within the preset time, and when the processing unit 5 first receives the induction signal sent by the first testing mechanism 401 or the second testing mechanism 402, the processing unit 5 is configured to start timing. When the processing unit 5 receives the first trigger signal, namely when the screw 2 is inserted in the first hole 4114, the processing unit 5 records a first period of time and records the number of subsequent first periods of time within the preset time. The first period of time is time interval between the time that the processing unit 5 receives the induction signal and the time that the processing unit 5 receives the first trigger signal. When the processing unit 5 receives the second trigger signal, namely when the screw 2 is inserted in the third hole 4116, the processing unit 5 records a second period of time and records the number of subsequent second periods of time within the preset time. The second period of time is a time interval between the time that the processing unit 5 receives the first trigger signal and the time that the processing unit 5 receives the second trigger signal. When the processing unit 5 fails to receive the first trigger signal, namely when the screw 2 is extracted from the third hole 4116 and the first hole 4114 sequentially, the processing unit 5 records a third period of time and records the number of subsequent third periods of time within the preset time. The third period of time is a time interval between the time that the processing unit 5 receives second trigger signal and the time that the processing unit 5 fails to receive the first trigger signal. When the processing unit 5 fails to receive the induction signal sent by the sensor 42 (e.g., when the screw 2 is extracted from the first hole 4114), the processing unit 5 records a fourth period of time and records the number of subsequent fourth periods of time within the preset time. The fourth period of time is a time interval between the time that the processing unit 5 fails to receive the first trigger signal and the time that the processing unit 5 fails to receive the induction signal. When the processing unit 5 receives the induction signal sent by the sensor 42 of the second testing mechanism 402 or the first testing mechanism 401, namely when the screw 2 is inserted into the first hole 4114 of the second testing mechanism 402 or the first testing mechanism 401, the processing unit 5 records a fifth period of time and records the number of subsequent fifth periods of time within the preset time. The fifth period of time is a time interval between the time that the processing unit 5 fails to receive the induction signal of one testing mechanism 4 and the time that the processing unit 5 receives the induction signal of the other testing mechanism 4 of the two mechanisms 4. The processing unit 5 analyzes and generates testing result according to the recorded first period of time and the number of subsequent first periods of time, the recorded second period of time and the number of subsequent second periods of time, the recorded third period of time and the number of subsequent third periods of time, the recorded fourth period of time and the number of subsequent fourth periods of time, and the recorded fifth period of time and the number of subsequent fifth periods of time. The processing unit 5 further sends the generated testing result and all the recorded periods of time and the numbers of periods of time to the electronic device for the user to view.

In at least one embodiment, the device 100 further includes an indication unit 8. The indication unit 8 is used to remind the user to operate the device 100 for testing finger dexterity. In at least one embodiment, the indication unit 8 includes four indicating lights. The first testing mechanism 401 corresponds to two indicating lights. The second testing mechanism 402 corresponds to another two indicating lights. The two indicating lights include a first indicating light 81 and a second indicating light 82. When receiving the first trigger signal, the processing unit 5 lights up the first indicating light 81, when receiving the second trigger signal, the processing unit 5 lights up the second indicating light 82.

The device 100 executes the process of testing user's finger dexterity as follows. First, the user applies a screwdriver 3 to the top part 20 of the screw 2 and inserts the bump 22 of the screw 2 into the second hole 4115 of the screw hole 411. The column body 21 of the screw 2 is inserted into the first hole 4114 of the screw hole 411, causing the sensor 42 to produce the induction signal as the sensor 42 senses the screw 2 and causing the processing unit 5 to time when receiving the induction signal sent by the sensor 42. Then, the user uses the screwdriver 3 to insert the screw 2 into the screw hole 411 to make the bump 22 into the third hole 4116 of the screw hole 411 and make the column body 21 of the screw 2 rest on the metal conductive sheet 43, causing the screw 2 to contact with the first conductive point 4113 in the first hole 4114 and the second conductive point 431 on the metal conductive sheet 43. The circuit board 46 thus produces the first trigger signal. When the processing unit 5 receives the first trigger signal, the processing unit 5 records the first period of time, records the number first periods of time within the preset time and lights up the first indicating light 81. Then, the user uses the screwdriver 4 to rotate the screw 2 at a preset angle along a clockwise direction to make the bump 22 of the screw 2 make contact with first conductive point 4113 in the third hole 4116, causing the screw 2 to make contact with the first conductive point 4113 in the third hole 4116 and the second conductive point 431 on the metal conductive sheet 43. The circuit board 46 is thereby caused to produce the second trigger signal, and when the processing unit 5 receives the second trigger signal, the processing unit 5 records the second period of time, records the number of subsequent second periods of time within the preset time and lights up the second indicating light 82. In at least one embodiment, the preset angle can be 180 degrees. Then, the user uses the screwdriver 3 to rotate the screw 2 along the preset angle along counterclockwise direction to extract the screw 2, breaking contact with the first conductive point 4113 in the third hole 4116. The second trigger signal thus ceases, and when the processing unit 5 fails to receive the second trigger signal, the processing unit 5 extinguishes the second indicating light 82. Then, the user uses the screwdriver 3 to extract the screw 2 from the third hole 4116 to break contact with the second conductive point 431 on the metal conductive sheet 43, thus, causing the circuit board 46 to fail to produce the first trigger signal. When the processing unit 5 fails to receive the first trigger signal, the processing unit 5 records the third period of time, records the number of subsequent third periods of time within the preset time and extinguishes the first indicating light 81. Then, the user uses the screwdriver 3 to fully extract the screw 2 from the screw hole, causing the sensor 42 to fail to produce the induction signal. When the induction signal sent by the sensor 5 ceases, the processing unit 5 records the fourth period of time and records the number of subsequent fourth periods of time within the preset time. Then, the user again uses the screwdriver 3 to insert the bump 22 of the screw 2 into the second hole 4115 of the screw hole 411 and inserts the column body 21 of the screw 2 into the first hole 4114 of the screw hole 411, causing the sensor 42 produces the induction signal as the sensor 42 senses the screw 2. When the processing unit 5 receives the induction signal sent by the sensor 42, the processing unit 5 records the fifth period of time and records the number of subsequent fifth periods of time within the preset time. Finally, the processing unit 5 analyzes and generates testing result according to the recorded periods of time and the numbers of periods of time. The processing unit 5 further sends the generated testing result to the electronic device through the communication unit 6.

In at least one embodiment, the processing unit 5 further sends the recorded periods of time and the numbers of periods of time to the electronic device through the communication unit 6.

In at least one embodiment, the device 100 further includes a display unit 9 (referring to FIG. 5). The processing unit 5 is also used to display the generated testing result on the display unit 9 for the user to view.

In at least one embodiment, the storage unit 7 stores a first reference time, a second reference time, a third reference time, a fourth reference time, and a fifth reference time. The first reference time, second reference time, third reference time, fourth reference time, and fifth reference time can be obtained through large number of testable users using the device 100. The processing unit 5 generates the testing results as follows. First, the processing unit 5 calculates a first time average value according to the recorded first period of time and the number of subsequent first periods of time, and determines a first scoring by comparing the calculated first time average with the first reference time. Then, the processing unit 5 calculates a second time average value according to the recorded second period of time and the number of subsequent second periods of time, and determines a second scoring by comparing the calculated second time average with the second reference time. The processing unit 5 calculates third, fourth, and fifth time average values and third, fourth, and fifth scorings in a similar way. Lastly, the processing unit 5 weighs and sums the determined first scoring, second scoring, third scoring, fourth scoring, and fifth scoring to a final scoring. The final scoring can be the testing result.

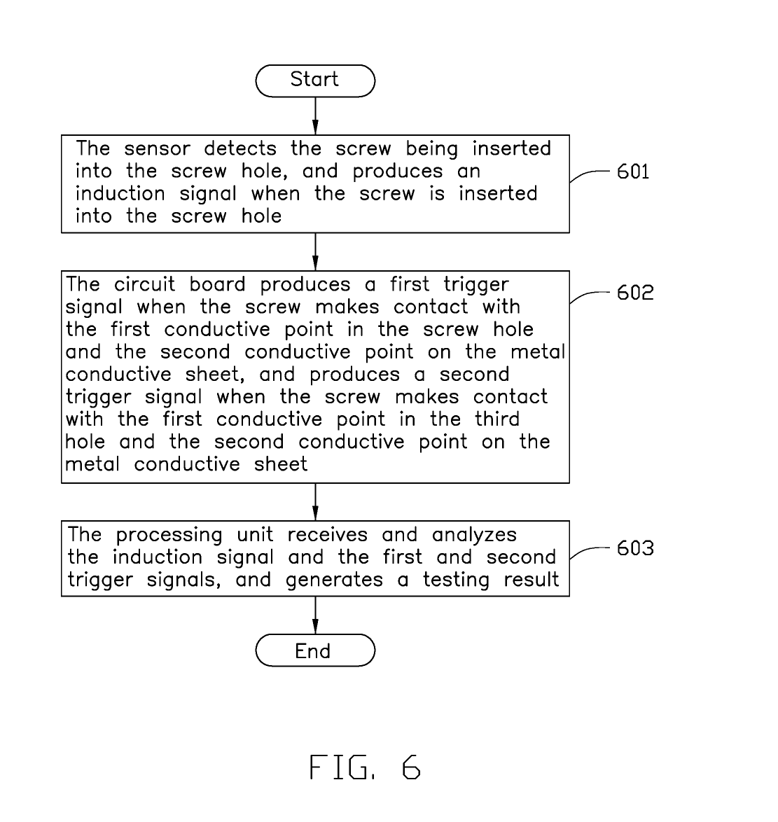

FIG. 6 illustrates a flowchart of one exemplary embodiment of a method for testing finger dexterity. The method is provided by way of example, as there are a variety of ways to carry out the method. The method described below can be carried out using the configurations illustrated in FIGS. 1-5, for example, and various elements of these figures are referenced in explaining the example method. Each block shown in FIG. 6 represents one or more processes, methods, or subroutines carried out in the example method. Furthermore, the illustrated order of blocks is by example only and the order of the blocks can be changed. Additional blocks may be added or fewer blocks may be utilized, without departing from this disclosure.

The method is run in a device for testing finger dexterity. The device includes at least one testing mechanism. The testing mechanism includes a base part, a sensor, a metal conductive sheet, and a processing unit. The base part defines a screw hole defining at least one first conductive point, the metal conductive sheet connects with a circuit board and defines a second conductive point. The example method can begin at block 601.

At block 601, the sensor detects the screw being inserted into the screw hole, and produces an induction signal when the screw is inserted into the screw hole.

At block 602, the circuit board produces a first trigger signal when the screw makes contact with the first conductive point in the screw hole and the second conductive point on the metal conductive sheet, and produces a second trigger signal when the screw makes contact with the first conductive point in the third hole and the second conductive point on the metal conductive sheet.

At block 603, the processing unit receives and analyzes the induction signal and the first and second trigger signals, and generates a testing result.

In at least one embodiment, the screw hole defines two first conductive points. The method further includes: the circuit board produces a first trigger signal when the screw makes contact with one first conductive point of the two conductive points and the second conductive point; or the circuit board produces a second trigger signal when the screw makes contact with the other first conductive point of the two first conductive points and the second conductive point.

Further, the method further includes: When receiving the induction signal sent by the sensor, the processing unit timing; when receiving the first trigger signal, the processing unit records the first period of time, and records the number of subsequent first periods of time within the preset time; when receiving the second trigger signal, the processing unit records the second period of time, and records the number of subsequent second periods of time within the preset time; when fails to receive the first trigger signal, the processing unit records the third period of time, and records the number of subsequent third periods of time within the preset time; when fails to receive the induction signal sent by the sensor, the processing unit records the fourth period of time and records the number of subsequent fourth periods of time within the preset time; when again receiving the induction signal sent by the sensor, the processing unit records the fifth period of time and records the number of subsequent fifth periods of time within the preset time; and the processing unit analyzes and generates the testing result according to the recorded periods of time and the numbers of periods of time.

Further, the method further includes: the processing unit calculates a first time average value according to the recorded first period of time and the number of subsequent first periods of time, and determine a first scoring by comparing the calculated first time average with a stored first reference time; calculate a second time average value according to the recorded second period of time and the number of subsequent second periods of time, and determine a second scoring by comparing the calculated second time average with a stored second reference time; calculate a third time average value according to the recorded third period of time and the number of subsequent third periods of time, and determines a third scoring by comparing the calculated third time average with a stored third reference time; calculate a fourth time average value according to the recorded fourth period of time and the number of subsequent fourth periods of time, and determine a fourth scoring by comparing the calculated fourth time average with a stored fourth reference time; calculate a fifth time average value according to the recorded fifth period of time and the number of subsequent fifth periods of time, and determine a fifth scoring by comparing the calculated fifth time average with a stored fifth reference time; and weigh and sum the determined first scoring, second scoring, third scoring, fourth scoring, and fifth scoring to a final scoring acted as the testing result.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A device for testing finger dexterity, comprising:
a box comprising a shell;
a testing mechanism mounted on the shell, the testing mechanism comprising:
a base part defining a screw hole, the screw hole comprising an open end, a bottom end opposite to the open end, and a first conductive point located between the open end and the bottom end;
a sensor set on the base part and configured to detect a screw being inserted into the screw hole and produce an induction signal when the screw is inserted into the screw hole;
a metal conductive sheet set on the bottom end, the metal conductive sheet defining a second conductive point;
a circuit board connecting with the metal conductive sheet, wherein, the circuit board produces a first trigger signal when the screw makes contact with the first conductive point and the second conductive point; and
a processing unit connecting with the sensor and the circuit board, the processing unit configured to receive and analyze the induction signal sent by the sensor and the first trigger signal sent by the circuit board within a preset time, and generate a testing result.

2. The device according to claim 1, wherein the screw hole comprises a first hole, a second hole, and a third hole, one end of the first hole and one end of the second hole connect with the open end, the other end of the first hole and the other end of the second hole connects with the third hole, the third hole connects with the bottom end.

3. The device according to claim 1, wherein the device further comprises a communication unit, the processing unit further sends the generated testing result to an electronic device through the communication unit.

4. The device according to claim 1, wherein the device further includes an indication unit the indication unit is configured to remind a user to operate the device for testing finger dexterity.

5. The device according to claim 2, wherein the screw hole further comprises a third conductive point, the first conductive point is set on an inner wall of the first hole, the third conductive point is set on an inner wall of the third hole.

6. The device according to claim 5, wherein when the screw makes contact with the first conductive point and the second conductive point, the circuit board produces the first trigger signal; and when the screw makes contact with the third conductive point and the second conductive point, the circuit board produces a second trigger signal.

7. The device according to claim 5, wherein the screw comprises a top part, a column body, and a bump, the column body comprises a first end and a second end, the first end of the column body connects with the top part, the other end of the column body connects with the bump, when the screw is received in the screw hole, the column body is received in the first hole, the bump is received in the third hole, the top part is exposed above the first hole.

8. The device according to claim 5, wherein the screw is magnetic.

9. The device according to claim 6, wherein when receiving the induction signal sent by the sensor, the processing unit being configured to start timing; when receiving the first trigger signal, the processing unit records a first period of time, and records a number of subsequent first periods of time within the preset time; when receiving the second trigger signal, the processing unit records a second period of time, and records a number of subsequent second periods of time within the preset time; when failing to receive the first trigger signal, the processing unit records a third period of time, and records a number of subsequent third periods of time within the preset time; when failing to receive the induction signal sent by the sensor, the processing unit records a fourth period of time and records a number of subsequent fourth periods of time within the preset time; when again receiving the induction signal sent by the sensor, the processing unit records a fifth period of time and records a number of subsequent fifth periods of time within the preset time; and analyzes and generates the testing result according to the recorded first period of time, the recorded second period of time, the recorded third period time, the recorded fourth period time, the recorded fifth period time, the number of subsequent first periods of time, the number of subsequent second periods of time, the number of subsequent third periods of time, the number of subsequent fourth periods of time, and the number of subsequent fifth periods of time.

10. The device according to claim 9, wherein the processing unit is further configured to:
calculate a first time average value according to the recorded first period of time and the number of subsequent first periods of time, and determine a first scoring by comparing the calculated first time average with a first reference time;
calculate a second time average value according to the recorded second period of time and the number of subsequent second periods of time, and determine a second scoring by comparing the calculated second time average with a second reference time;
calculate a third time average value according to the recorded third period of time and the number of subsequent third periods of time, and determines a third scoring by comparing the calculated third time average with a third reference time;
calculate a fourth time average value according to the recorded fourth period of time and the number of subsequent fourth periods of time, and determine a fourth scoring by comparing the calculated fourth time average with a fourth reference time;
calculate a fifth time average value according to the recorded fifth period of time and the number of subsequent fifth periods of time, and determine a fifth scoring by comparing the calculated fifth time average with a fifth reference time; and
weigh and sum the determined first scoring, second scoring, third scoring, fourth scoring, and fifth scoring to a final scoring as the testing result.

11. A method for testing finger dexterity, run in a device for testing finger dexterity, the device comprising at least one testing mechanism, the testing mechanism comprising a base part, a sensor, a metal conductive sheet, and a processing unit, the base part defining a screw hole, the screw hole defining at least one first conductive point, the metal conductive sheet connecting with a circuit board and defining a second conductive point, the method comprising:
detecting a screw being inserted into the screw hole, and producing an induction signal when the screw is inserted into the screw hole;
producing a first trigger signal when the screw makes contact with the first conductive point and the second conductive point; and
receiving and analyzing the induction signal and the trigger signal, and generates testing result.

12. The method according to claim 11, further comprising:
producing a second trigger signal when the screw makes contact with a third conductive point and the second conductive point, wherein the third conductive point is defined in the screw hole.

13. The method according to claim 12, further comprising:
timing when receiving the induction signal sent by the sensor;
recording a first period of time and records a number of subsequent first periods of time within the preset time when receiving the first trigger signal;
recording a second period of time and recording a number of subsequent second periods of time within the preset time when receiving the second trigger signal;
recording a third period of time and recording the number of subsequent third periods of time within the preset time when failing to receive the first trigger signal;
recording a fourth period of time and recording a number of subsequent fourth periods of time within the preset time when failing to receive the induction signal sent by the sensor;
recording a fifth period of time and recording a number of subsequent fifth periods of time within the preset time when again receiving the induction signal sent by the sensor; and
analyzing and generating the testing result according to the recorded first period of time, the recorded second period of time, the recorded third period time, the recorded fourth period time, the recorded fifth period time, the number of subsequent first period of time, the number of subsequent second period of time, the number of subsequent third period of time, the number of subsequent fourth period of time, and the number of subsequent fifth period of time.

14. The method according to claim 13, further comprising:
calculating a first time average value according to the recorded first period of time and the number of subsequent first periods of time, and determining a first scoring by comparing the calculated first time average with a first reference time;
calculating a second time average value according to the recorded second period of time and the number of subsequent second periods of time, and determining a second scoring by comparing the calculated second time average with a second reference time;
calculating a third time average value according to the recorded third period of time and the number of subsequent third periods of time, and determining a third scoring by comparing the calculated third time average with a third reference time;
calculating a fourth time average value according to the recorded fourth period of time and the number of subsequent fourth periods of time, and determining a fourth scoring by comparing the calculated fourth time average with a fourth reference time;
calculating a fifth time average value according to the recorded fifth period of time and the number of subsequent fifth periods of time, and determining a fifth scoring by comparing the calculated fifth time average with a fifth reference time; and
weighing and summing the determined first scoring, second scoring, third scoring, fourth scoring, and fifth scoring to a final scoring as the testing result.
